(19) United States
(12) Patent Application Publication
(10) Pub. No.: US 2015/0132199 A1
(43) Pub. Date: May 14, 2015

(54) LABORATORY VESSELS AND METHODS OF MANUFACTURING THEREOF

(71) Applicant: Michelle Han, San Francisco, CA (US)

(72) Inventor: Michelle Han, San Francisco, CA (US)

(21) Appl. No.: 14/076,272

(22) Filed: Nov. 11, 2013

(51) Int. Cl. B01L 3/00; B29D 23/00; B29C 49/00

(52) U.S. Cl. CPC B01L 3/00; B29C 49/0047; B29D 23/00; B29C 2049/0057; B29K 2101/00
USPC 422/547; 264/545

(57) ABSTRACT

A laboratory vessel assembly includes a vessel body with a closed end, an open end, an engaging portion disposed inbetween, and two edges disposed longitudinally on two opposite portions of an outer surface of the engaging portion of the vessel body along one or more fusion lines of the vessel body; a vessel cap with a closed end, an open end, a receiving portion disposed inbetween, and one or more grooves disposed on an inner surface of the receiving portion along one or more fusion lines of the vessel cap; wherein the receiving portion of the vessel cap is configured to engage with the engaging portion of the vessel body to create one or more aeration gaps between the vessel body and the vessel cap along the grooves of the vessel cap and/or the edges of the vessel body.

### BACKGROUND

Present disclosure relates generally to the field of laboratory device, and more specifically, to laboratory vessels and methods of manufacturing thereof.

Various vessel assemblies are used in a laboratory setting as test vessels, reaction vessels, culture vessels or the like. Typical functions of laboratory vessels include maintaining a clean and sterile environment inside a vessel body, preventing the contents in a vessel body from spilling, and preventing the contents in a vessel body from evaporating. To accomplish these functions, a laboratory vessel body is typically covered or closed by a cap. For other functions, such as to keep the interior of a laboratory vessel properly aerated for biological culture and some reactions, specifically designed caps and/or vessel bodies may be used.

The design of the cap and vessel body and the resulting interaction between the cap and the vessel body often involve several considerations. For example, dural position snap cap tubes such as the BD Falcon™ tube by Becton, Dickinson and Company of Franklin Lakes, N.J., U.S. is configured with ridge space arranged on the inner surface of the cylindrical side wall of the cap to maintain an aerobic environment within the vessel body for microbiological procedures when it is in a covered, but unsealed position. This vessel assembly can be transformed to a fully sealed position where the cap fully engages with the vessel body for anaerobic use, storage transfer or centrifuge applications.

In another example, T-flasks such as the Corning® canted flask by Corning Inc. of New York, N.Y., U.S., are used for static cell culture. T-flasks are typically used with two different cap configurations. One configuration is a filter cap, which contains vent filter typically disposed on the top surface of the cap to achieve constant aeration; another configuration is a seal cap or a plug seal cap, which achieves aeration through the gaps between the cap and the open end of the vessel created by either ridges on the cap inner surface or by discontinued threads on inner surface of the cap sidewall and the open end of the vessel when loosely covered.

Since a cap of a laboratory vessel assembly often must be removed periodically to access the interior of the vessel body, it is common for a laboratory worker to place the cap top-down on a work surface while they are accessing the interior of the vessel body. This procedure exposes the content of the vessel to contamination and creates the potentials of mis-capping the vessel body. Furthermore, these vessel body and cap combinations may require a laboratory worker to use two hands to manipulate the cap. Although a laboratory worker may hold the vessel with one hand and simultaneously may use his or her thumb and forefinger of the same hand to open the cap, however, this is a skilled operation and requires capping with great care to minimize contamination caused by contacting the opening of the vessel body. In addition, the single unit cap vessel configuration will require extra interconnectors between vessels or the like to adapt to automatic sample handlings and testing procedures.

In order to avoid the need to place the cap on a laboratory work surface while the interior of the tube is being accessed, some vessels have been manufactured with a flip cap to provide certain handling efficiency by permitting one-handed opening.

Flip cap vessels, such as the Nunc® EZ Flip™ conical tube by Sigma Aldrch of St. Louis, Mo., U.S. and as disclosed in U.S. Pat. No. 8,172,101 assigned to Becton, Dickinson and Company, typically contain a cap that is threaded or strapped or otherwise mounted to the vessel body. Alternatively, flip cap vessels may be configured as a multiplicity of equally spaced regent tubes with integrally connected caps as disclosed in U.S. Pat. No. 6,601,725 assigned to 3088081 Canada, Inc; U.S. Pat. Nos. 7,717,284 and 7,546,931, both assigned to Becton, Dickinson and Company; and U.S. Pat. Nos. 5,683,659 and 5,722,553 both by Kenneth Hovatter.

Although an integral cap vessel, such as a flip cap vessel, addresses some of the shortcomings of the snap cap vessel, the integral connection of the cap and the vessel body may impact or limit the cap movement. For example, the movement of the vessel cap may be too restrictive, where the cap movement is limited to just one axis. Alternatively, the cap movement of a flip cap vessel may be too unrestrictive, where there is minimal structural support to aid in the placement of the cap, especially as observed in a flip cap vessel with a tethered hinge.

As briefly described above, various configurations of laboratory vessels suffer from one or more shortcomings including difficulties in manipulating the caps, the possibility of misplacing the caps, contamination potential, suitability for automatic handling, aeration maintenance and/or high cost in manufacturing. At least some of the shortcomings are addressed by the embodiments of the present disclosure.

### SUMMARY

Embodiments include various laboratory vessel assemblies and various methods of manufacturing thereof.

In one aspect, a laboratory vessel assembly comprises a vessel body with a first part and a second part fused together along one or more fusion lines; wherein the vessel body comprises a closed end, an open end, and an engaging portion disposed inbetween with two edges disposed longitudinally on two opposite portions of an outer surface of the engaging portion of the vessel body along the fusion lines of the vessel body. The laboratory vessel assembly further comprises a vessel cap with a first part and a second part fused together along one or more fusion lines, wherein the vessel cap comprises a closed end, an open end, and a receiving portion disposed inbetween with one or more grooves disposed on an inner surface of the receiving portion along the fusion line of the vessel cap; wherein the receiving portion of the vessel cap is configured to engage with the engaging portion of the vessel body to create one or more aeration gaps between the vessel body and the vessel cap along the grooves of the vessel cap or the edges of the vessel body

In another aspect, a laboratory vessel assembly comprises a vessel body with a closed end, an open end, and an engaging portion disposed inbetween. Two edges are disposed longitudinally on two opposite portions of an outer surface of the engaging portion. The laboratory vessel assembly further comprises a vessel cap with a closed end, an open end, and a receiving portion disposed in between with one or more grooves disposed on an inner surface of the receiving portion. The vessel body and the vessel cap are linked or connected by a shaft, wherein the vessel cap is configured to be movable along at least two axes such that the vessel cap is capable of linear movement along the first axis and rotational movement along the second axis which is perpendicular or parallel to the first axis and wherein the vessel cap is capable of transforming from a position where the receiving portion of the vessel cap is engaged with the engaging portion of the vessel body to a position where the receiving portion of the cap is disengaged with the engaging portion of the vessel body.

In another aspect, a method of manufacturing a laboratory vessel body by positive pressure forming such as blow molding comprises heating two sheets of base material to fuse the sheets along one or more predetermined fusion lines in a mold; injecting gas to a space between the fused sheets to create an embryonic vessel assembly; cutting the embryonic vessel assembly along a first set of one or more cutting lines to produce one or more openings of the vessel body, and cutting the embryonic vessel assembly along a second set of one or more cutting lines to produce two edges on an outer surface of the engaging portion of the vessel body.

This, and further aspects of the present embodiments are set forth herein.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1A illustrates a front perspective view of one embodiment of a laboratory vessel assembly configured as a tube assembly comprising a cap with grooves and a vessel body with edges.

FIG. 1B illustrates a side perspective view of one embodiments of a laboratory vessel assembly configured as a tube assembly comprising a cap with grooves and a vessel body with edges.

FIG. 1C illustrates a detail view of one embodiment of a laboratory vessel cap with grooves as seen in FIG. 1A and FIG. 1B.

FIG. 2A illustrates a front perspective view of one embodiment of a laboratory vessel assembly configured as a flask assembly comprising a cap with grooves and a vessel body with edges.

FIG. 2B illustrates a side perspective view of one embodiment of a laboratory vessel assembly configured as a flask assembly comprising a cap with grooves and a vessel body with edges.

FIG. 2C illustrates a detail view of one embodiment of a laboratory vessel cap with grooves as seen in FIG. 2A and FIG. 2B.

FIG. 3A illustrates a front perspective view of an embodiment of a laboratory vessel assembly configured as a tube assembly where the cap is engaged with the vessel body to form aeration gaps.

FIG. 3B illustrates a front perspective view of an embodiment of a laboratory vessel assembly configured as a flask assembly where the cap is engaged with the vessel body to form aeration gaps.

FIG. 3C illustrates a cross sectional perspective view of an embodiment of a laboratory vessel assembly where the cap is engaged with the vessel body to form aeration gaps.

FIG. 4 illustrates one perspective of an embodiment of a laboratory vessel assembly comprising a plurality of connected vessel bodies and caps.

FIG. 5A illustrates a front perspective view of an embodiment of a laboratory vessel assembly configured as a tube assembly comprising a vessel body and a vessel cap where the cap comprises one or more ridges.

FIG. 5B illustrates a front perspective view of an embodiment of a laboratory vessel assembly configured as a flask assembly comprising a vessel body and a vessel cap where the cap comprises one or more ridges.

FIG. 5C illustrates a cross sectional perspective view of an embodiment of a laboratory vessel assembly comprising a vessel body and a vessel cap where the cap comprises one or more ridges.

FIG. 6A illustrates a view of an embodiment of a laboratory vessel assembly configured as a tube assembly comprising threads disposed on the cap and corresponding threads disposed on an engaging portion of the vessel body.

FIG. 6B illustrates a view of an embodiment of a laboratory vessel assembly configured as a flask assembly comprising threads disposed on the cap and corresponding threads disposed on an engaging portion of the vessel body.

FIG. 7A illustrates one perspective of an embodiment of a laboratory vessel assembly configured as a tube assembly comprising a vessel body and a cap connected by a shaft, where the vessel cap is rotatably positioned away from the vessel body.

FIG. 7B illustrates one perspective of an embodiment of a laboratory vessel assembly configured as a tube assembly comprising a vessel body and a cap connected by a shaft, where the vessel cap is linearly positioned away from the vessel body.

FIG. 7C illustrates one perspective of an embodiment of a laboratory vessel assembly configured as a tube assembly comprising a vessel body and a cap connected by a shaft, where the cap is engaged with the vessel body.

FIG. 8A illustrates one perspective of an embodiment of a laboratory vessel assembly configured as a flask assembly comprising a vessel body and a cap connected by a shaft, where the vessel cap is rotatably positioned away from the vessel body.

FIG. 8B illustrates one perspective of an embodiment of a laboratory vessel assembly configured as a flask assembly comprising a vessel body and a cap connected by a shaft, where the vessel cap is linearly positioned away from the vessel body.

FIG. 8C illustrates one perspective of an embodiment of a laboratory vessel assembly configured as a flask assembly comprising a vessel body and a cap connected by a shaft, where the cap is engaged with the vessel body.

FIG. 9A illustrates an embodiment comprising a plurality of vessel bodies and caps connected by shafts, where the caps are disengaged with the vessel bodies.

FIG. 9B illustrates an embodiment of a plurality of vessel bodies and caps connected by shafts, where the caps are engaged with the vessel bodies.

FIG. 10A illustrates one perspective of an embodiment of a vessel body and a cap connected by a bendable shaft, where the cap is linearly positioned away from the vessel body.

FIG. 10B illustrates another perspective of an embodiment of a laboratory vessel assembly comprising a vessel body and a cap connected by a bendable shaft, where the cap is disengaged from the vessel body by bending the shaft.

FIG. 10C illustrates yet another perspective of an embodiment of a laboratory vessel assembly comprising a vessel body and a cap connected by a bendable shaft, where the cap is disengaged and rotated away from the vessel body.

FIG. 11A illustrates one perspective of another embodiment of a laboratory vessel assembly comprising a vessel cap that is integrally connected to a shaft with locking elements, wherein the shaft is received by a receiving sheath that is integrally connected to a vessel body.

FIG. 11B illustrates one perspective of another embodiment of a laboratory vessel assembly comprising a vessel body that is integrally connected to a shaft with locking elements, wherein the shaft is received by a receiving sheath that is integrally connected to a vessel cap.

FIG. 11C illustrates one perspective of another embodiment of a laboratory vessel assembly comprising a vessel cap that is integrally connected to a bendable shaft with locking elements, wherein the shaft is received by a receiving sheath that is integrally connected to a vessel body.

FIG. 12 illustrates a flow diagram of one method of manufacturing a laboratory vessel assembly by implementing plastic chip positive pressure forming.

FIG. 13 illustrates exemplarily the steps of one embodiment of manufacturing laboratory vessel assembly by implementing plastic chip positive pressure forming.

FIG. 14 illustrates exemplarily the steps of another embodiment of manufacturing laboratory vessel assembly by implementing a multi-cutting methodology.

FIG. 15 illustrates a flow diagram of one method of manufacturing a laboratory vessel assembly by implementing plastic chip negative pressure forming.

FIG. 16 illustrates the steps of one embodiment of manufacturing a laboratory vessel assembly by implementing plastic chip negative pressure forming.

FIG. 17 illustrates the steps of one embodiment of processing the openings of the laboratory vessel assemblies.

FIGS. 18A-18G illustrates embodiments of embryonic vessel components and the resulting vessel assembly components.

FIG. 19 illustrates one perspective of an embodiment of manufacturing a vessel cap with a bendable shaft assembly.

### DETAILED DESCRIPTION

While the invention has been disclosed with reference to certain embodiments, it will be understood by those skilled in the art that various changes may be made and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate like parts throughout the views. Additionally, a reference to the singular includes a reference to the plural unless otherwise stated or inconsistent with the disclosure herein.

The word “exemplary” is used herein to mean “serving as an example, instance, or illustration.” Any implementation described herein as “exemplary” is not necessarily to be construed as advantageous over other implementations.

The term “laboratory vessel” is used herein to mean test tubes of various sizes and shapes, flasks of various shapes and sizes including but not limited to round-bottom flasks, dewar flasks, Erlenmeyer flasks, Buchner flasks, tissue culture flasks (T-flask) of various growth area, and any other vessels used in a laboratory setting for tissue culture, testing, storage, and the like with various sizes, shapes, and configurations including but not limited to rhombus, lozenge, rhomb, diamond shape, a right hexagon shape, or other shapes. It is further noted that the laboratory vessel may comprise a vessel body of various sizes, shapes and configurations with at least one opening and a cap of various sizes, shapes and configurations corresponding to at least one opening of the vessel body.

It is noted that various materials may be used to manufacture a laboratory vessel assembly including, but not limited to PVC, PE, PP, PVDC, PVC/PE, PS/PE and PET/PE chips, and other copolymer plastic chips or sheets. It is further contemplated that the embodiments of the laboratory vessel assembly may be made of glass or other suitable materials.

The present disclosure provides for embodiments of laboratory vessel assembly with a vessel body and a vessel cap, wherein the vessel cap is configured to be placed over an opening of the vessel body to form aeration gaps. In one aspect, upon engagement of the vessel cap and the vessel body, aeration gaps configured to achieve a desired degree of ventilation of a space within the vessel body are formed between edges disposed on the outer surface of the vessel body and/or grooves disposed on the inner surface of the vessel cap. In another aspect, the present disclosure provides for embodiments of laboratory vessel assembly with a vessel body and a vessel cap, wherein the cap is configured to be placed over an opening of the vessel body such that the cap is in engagement therewith, wherein an operator may rapidly handle multiple samples.

In another aspect, the present disclosure further provides for embodiments of laboratory vessel assembly with a vessel body, a cap, and a shaft linking or connecting the cap and the vessel body. The vessel cap is configured to be movable along two or more axes such that the cap is capable of transforming from a position where the cap is engaged with the vessel body to a position where the cap is disengaged with the vessel body.

In yet another aspect, the present disclosure provides for embodiments of manufacturing laboratory vessel assembly by combining or fusing one or more units of base material to form embryonic vessels via positive pressure forming (i.e., blow-molding) or negative pressure forming (i.e., vacuum forming), cutting the embryonic vessels, and removing waste portions to produce laboratory vessel components.

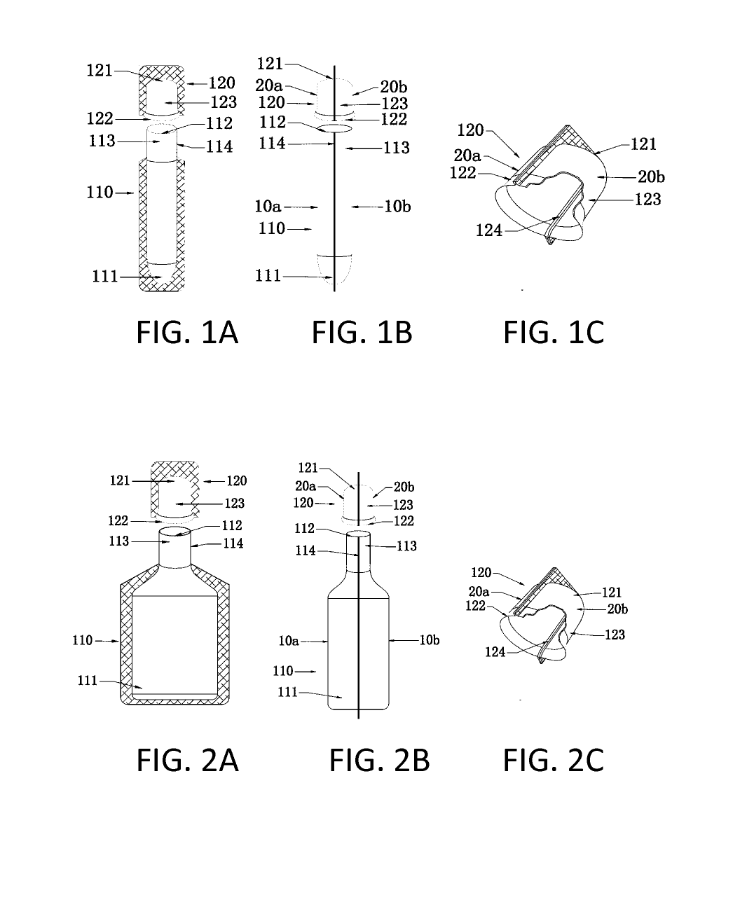

Referring now to FIGS. 1A-1C and FIGS. 2A-2C, where embodiments of a laboratory vessel assembly are exemplarily shown. As seen in FIGS. 1A-1C, the laboratory vessel assembly may be configured as a tube assembly, also as seen in FIGS. 2A-2C, the laboratory vessel assembly may be configured as a flask assembly. As previously mentioned, the laboratory vessel assembly may assume various configurations, although the laboratory vessel assembly as illustrated and described herein as a tube assembly or a flask assembly, such descriptions are illustrative only and should not be construed as limiting.

As seen in FIG. 1A and FIG. 2A, the laboratory vessel assembly comprises a vessel body 110 and a vessel cap 120. The vessel body 110 comprises a closed end 111, an open end 112, with a body disposed inbetween. The vessel body 110 further comprises an engaging portion 113 that is configured to engage, connect, or couple with a portion of the vessel cap 120, such as the receiving portion 123. In one embodiment, the engaging portion 113 includes the open end 112 and at least a portion of the body.

The vessel cap 120 comprises a closed end 121, an open end 122, with a body disposed inbetween. The vessel cap 120 further comprises a receiving portion 123 that is configured to engage, connect, or couple with a portion of the vessel body 110, such as the engaging portion 113. In one embodiment, to enable or facilitate the engagement of the vessel cap 120 with the vessel body 110, a diameter of the open end 122 of the vessel cap 120 is configured to be greater than a diameter of the receiving portion 123 of the vessel body 110.

In another embodiment, to facilitate the engagement and the disengagement of the receiving portion 123 of the vessel cap 120 with the engaging portion 113 of the vessel body 110, a diameter of the open end 122 of the vessel cap 120 is configured to be greater than a diameter of the closed end 121 of the vessel cap 120 such that the receiving portion 123 of the vessel cap 120 and/or substantially the entire vessel cap 120 assumes a bell bottom shaped configuration.

In one embodiment, the vessel body 110 and/or the vessel cap 120 is constructed by fusing two parts along one or more fusion lines. In one embodiment, a first body part 10a and a second body part 10b are fused together along one or more fusion lines to form the vessel body 110 as seen in FIGS. 1B and 2B by applying one or more methods of manufacturing described in greater detail below. Similarly, a first cap part 20a and a second cap part 20b are fused together along one or more fusion lines to form the vessel cap 120 as seen in FIGS. 1B, 1C, 2B, and 2C by applying one or more methods of manufacturing described in greater detail below.

As seen in FIG. 1B and FIG. 2B, in one embodiment, the vessel body 110 comprises at least two edges 114 disposed longitudinally on two opposite portions of an outer surface of the vessel body 110, such as an outer surface of the engaging portion 113. The edges 114 form regions of positive space, i.e., protrusions, on the outer surface of the vessel body 110. In one embodiment, the edges 114 are disposed along the fusion lines of the first body part 10a and the second body part 10b to form fusion edges along or around the engaging portion 113 of the vessel body 110. Additionally or alternatively, the edges may be configured as a frame disposed continuously around the closed end 111 and at least a portion of the body of the vessel body 110.

As seen in FIG. 1C and FIG. 2C, in one embodiment, the vessel cap 120 comprises one or more grooves 124 disposed longitudinally on two opposite portions of an inner surface of the vessel cap 120, such as an inner surface of the receiving portion 123. The grooves 124 form regions of negative space i.e., indentation, on the inner surface of the vessel cap 120. In one embodiment, the grooves 124 are disposed along the fusion lines of the first cap part 20a and the second cap part 20b to form fusion grooves along or around the receiving portion 123 of the vessel cap 120. Additionally or alternatively, the grooves may be configured as a rim disposed continuously around a circumference of the engaging portion of the vessel cap 120.

In one embodiment, the grooves 124 may be configured with various depths depending on the manufacturing methodology, construction material, and the degree of aeration desired for the laboratory vessel assembly. Similarly, in one embodiment, the edges 114 may be configured with various degree of protrusions depending on the manufacturing methodology, construction material, and the degree of aeration needed for the vessel assembly.

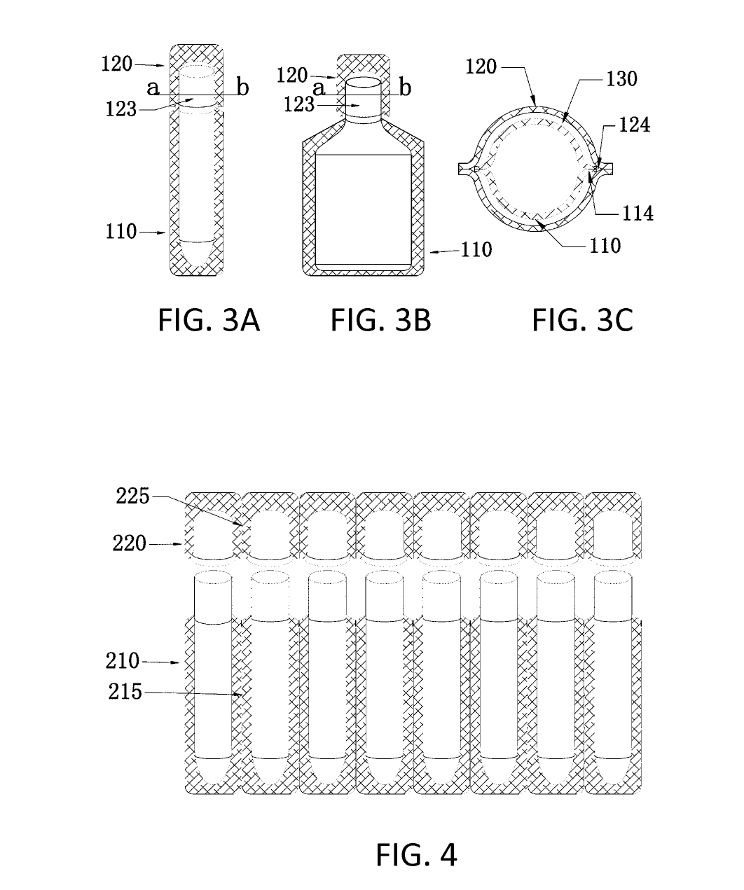

Referring now to FIGS. 3A-3C, where embodiments of a laboratory vessel assembly are exemplarily shown. In one embodiment, as seen in FIG. 3A, where the laboratory vessel assembly is configured as a tube assembly and as seen in FIG. 3B, where the laboratory vessel assembly is configured as a flask assembly, the receiving portion 123 of the vessel cap 120 receives the engaging portion 113 of the vessel body 110, wherein the vessel cap 120 is engaged with the vessel body 120 such that the vessel assembly assumes a closed configuration. In the engaged configuration, an interior of the vessel body is isolated from the environment to minimize contamination, evaporation, and/or spillage.

As seen in FIG. 3C, where a cross section of the engaged configuration of the laboratory vessel assembly is exemplarily shown. One or more aeration gaps 130 configured to aerate the interior of the vessel body are formed between the vessel body 110 and the vessel cap 120 along the grooves 124 of the vessel cap 120 and/or the edges 114 of the vessel body 110. In one embodiment, as seen in FIG. 3C, the aeration gaps 130 are formed by engaging the edges 114 of the vessel body 110 with the grooves 124 of the vessel cap 120, where a portion of the edges 114 are at least partially inserted into the grooves 124. This embodiment may be advantageous since the engagement of the edges 114 and the grooves 124 produces a locking effect where the vessel cap 120 and the vessel body 110 are prevented from slipping and thereby aeration gaps 130 of substantially constant volume may be maintained. In another embodiment, the aeration gaps 130 may be produced without the direct interaction of the edges 114 and the grooves 124. In one embodiment, the edges 114 and grooves 124 interaction is not configured to sealingly engage with each other to seal the interior of the vessel body 110. Instead, even when the edges 114 engages with the grooves 124, some degree of movement is afforded to the edges 114 within the confine of the grooves 124.

It is noted that aeration gaps may be formed without the direct interaction between the grooves 124 and the edges 114. In one embodiment, the aeration gaps 130 are formed by engaging the edges 114 of the vessel body 110 with a part of the receiving portion 123 of the vessel cap 120. In another embodiment, the aeration gaps 130 are formed by engaging the grooves 124 of the vessel cap 120 with a part of the engaging portion 113 of the vessel body 110.

As seen in FIG. 4, a vessel body 210 may be connected to one or more vessel bodies at one or more connection portions to form a plurality of connected vessel bodies. In one embodiment, the vessel bodies are connected at a connection portion 215 that is disposed along the fusion lines of the vessel body 210. In one embodiment, the connected vessel bodies are configured to be parallel to one another and equally spaced apart to form an elongated vessel body strip.

Also as seen in FIG. 4, a vessel cap 220 may also be connected to one or more vessel caps at a connection portion 225 to form a plurality of connected vessel caps. In one embodiment, the vessel caps are connected at a connection portion 225 that is disposed along the fusion lines of the vessel caps 220. In one embodiment, the connected vessel caps are configured to be parallel to one another and equally spaced apart to form an elongated vessel cap strip. It is noted that the vessel body 210 may comprise edges and the vessel cap 220 may comprise grooves as described and as shown in FIGS. 1A-1C, 2A-2C, and 3A-3C.

In one embodiment, the spacing of the connected vessel caps are configured to correspond to the spacing of the connected vessel bodies such that the elongated vessel cap strip is configured to engage with the elongated vessel body strip to function as a strip vessel assembly. The strip vessel assembly may be used in manual and/or automated laboratory procedures to enable multiple procedures to be carried out concurrently.

Additionally or alternatively, in one embodiment, the connecting portions are configured as tear line connection portions where the connected vessel bodies are capable of being separated. For example, one vessel body is capable of being separated from the elongated vessel body strip by tearing along the tear line connection portions. Similarly, in one embodiment, the connected vessel caps are capable of being separated at a tear line connection portions, such as a perforated portion wherein one vessel cap is capable of being separated from the elongated vessel cap strip by tearing along the tear line connection portions. This embodiment may be advantageous for storage of the laboratory assemblies where the vessel bodies and the vessel caps are stored as vessel body strips and vessel cap strips, when a need for a vessel assembly arises, the user can separate one cap and on vessel body from the strips.

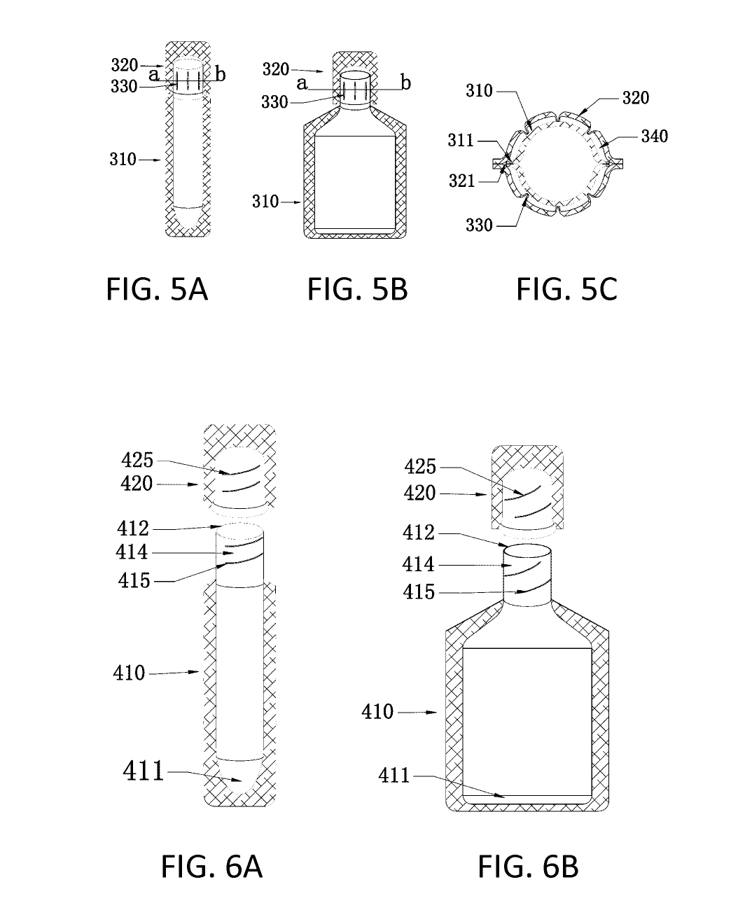

Referring now to FIGS. 5A-5B, where embodiments of the laboratory vessel assembly comprising ridges are shown. As seen in FIG. 5A, the laboratory assembly may be configured as a tube assembly and as seen in FIG. 5B, the laboratory assembly may be configured as a flask assembly. The laboratory vessel assembly as seen in FIG. 5A and FIG. 5B comprises a vessel body 310 and a vessel cap 320. The vessel cap 320 comprises one or more ridges 330 that are indented inwardly on the surface of the vessel cap 320.

Referring now to FIG. 5C, where a cross sectional view of the laboratory vessel assembly is shown. As previously described, the edges 311 disposed on an outer surface of the vessel body 310 is configured to interact with the grooves 321 disposed on the inner surface of the vessel cap 320 to create aeration gaps 340.

In one embodiment, the ridges 330 comprise inward protrusions to create additional points of contact between the vessel cap 320 and the vessel body 310. The additional points of contact as created by the ridges 330 indented on the vessel cap 320 may improve the interaction of the vessel cap 320 and the vessel body 310. For example, the additional points of contact between the vessel body 310 and the cap 320 enables better security between the vessel cap 320 to the vessel body 310 once engaged, thereby preventing the cap 320 from accidentally falling off or otherwise disengaging with the vessel body 310 while maintaining the aeration gaps 340 created between the vessel cap 320 and the vessel body 310. In one embodiment, the ridges 330 are produced by fusiform or spindle indentations to a portion of the vessel cap 330.

Additionally or alternatively, in one embodiment, as seen in FIG. 6A where the laboratory assembly is configured as a tube assembly and as seen in FIG. 6B where the laboratory assembly is configured as a flask assembly, a vessel body 410 comprises a closed end 411, an open end 412 and a body disposed inbetween. A plurality of discontinuous threads 415 disposed on the engaging portion 414 near the open end 412 of the vessel body 410. In one embodiment, the corresponding vessel cap 420 comprises corresponding threads 425 on the inner surface of the vessel cap 420. The thread configurations on the vessel body and/or the vessel cap increase the connections and contact points of the vessel cap with the vessel body when they are engaged in a closed configuration to prevent accidental separation of the vessel cap and the vessel body. Additionally, the discontinuous threads 415 of the vessel body 410 and the corresponding threads 425 of the vessel cap 420 may achieve aeration of an interior of the vessel body 410 through gaps created by the engagement thereof.

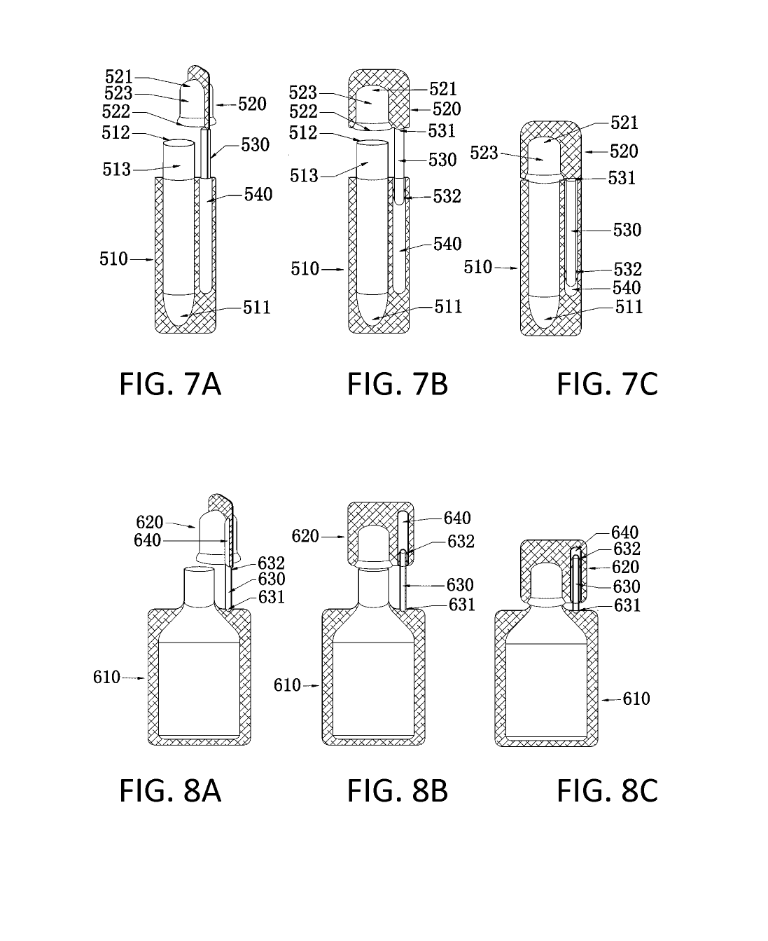

Embodiments of a laboratory vessel assembly configured as s tube assembly comprising a vessel body 510, a vessel cap 520 and a shaft 530 connecting or linking the vessel body 510 and the vessel cap 520 are shown in FIGS. 7A-7C.

The laboratory vessel assembly with a shaft connecting or linking the vessel cap and the vessel body may be advantageous to prevent the loss of the vessel cap, accidentally setting the vessel cap to a work bench thus increasing the risk of contamination, and the mismatch of the vessel body with the corresponding vessel cap. The vessel assembly with a shaft connecting or linking the vessel cap and the vessel body may be further advantageous to enable and facilitate one hand operation of the opening and closing of the vessel assembly.

The vessel body 510 as seen in FIGS. 7A-7C comprises a closed end 511, an open end 512, with a body comprising an engaging portion 513 disposed inbetween. The vessel cap 520 comprises a closed end 521, an open end 522, with a body comprising a receiving portion 523 disposed inbetween. The engaging portion 513 of the vessel body 510 is configured to engage, connect, or couple with the receiving portion 523 of the vessel cap 520. Furthermore, it is noted that in one embodiment, the engaging portion 513 of the vessel body 510 may comprise two edges disposed longitudinally on two opposite portions of an outer surface of the engaging portion 513. Similarly, it is noted that the receiving portion 523 of the vessel cap 520 one or more grooves disposed on an inner surface of the receiving portion 523.

In one embodiment, a receiving sheath 540 is integrally connected to the vessel body 510. As seen in FIGS. 7B-7C, in one embodiment, a first portion 531 of the shaft 530 may be integrally connected to the cap 520. A second portion of the shaft 532 is received by the receiving sheath 540 thereby connecting or linking the vessel cap 520 and the vessel body 510. In one embodiment, the receiving sheath 540 comprises an opening sufficiently narrowed as configured to permit a shaft 530 of being forced into the receiving sheath 540 and configured to prevent the shaft 530 from being pulled out from the sheath 540.

In one embodiment, the vessel cap 520 is configured to be movable along at least two axes. In one embodiment, the shaft 530 is configured to enable the vessel cap 520 to be independently capable of linear movement, such as vertical movement, along a first axis that is defined from the closed end 511 to the open end 512 of the vessel body 510. The shaft 530 is further configured to enable the vessel cap 520 to be independently capable of rotational movement along a second axis that is parallel or perpendicular to the first axis and/or with respect to the vessel body 510. In another embodiment, the shaft 530 is configured as a torsion hinge shaft capable of a hinge motion by pivoting the vessel cap 520 away from the vessel body 510.

As seen in FIG. 7A and FIG. 7B, the vessel cap 520 is configured to be capable of rotational movement. In one embodiment, the vessel cap 520 is capable of rotating around the shaft 530, with respect to the vessel body 510. The vessel cap 520 can rotationally transform from a position where the open end 522 and/or at least a part of the receiving portion 523 of the vessel cap 520 is substantially dis-aligned with the open end 512 or at least a part of the engaging portion 513 of the vessel body 510 (FIG. 7A) to a position where the open end 522 and/or a part of the receiving portion 523 of the vessel cap 520 is substantially aligned (i.e., where the engaging portion 513 and the receiving portion 523 are on the same axis) with the open end 512 and/or a part of the engaging portion 513 of the vessel body 510 (FIG. 7B).

Furthermore, as seen in FIG. 7B and FIG. 7C, the vessel cap 520 is configured to be capable of linear movement, by moving the vessel cap 520 up or down, with respect to the vessel body 510 where the vessel cap 520 can linearly transformed a position where the open end 522 and/or at least a part of the receiving portion 523 of the vessel cap 520 is substantially above the open end 512 and/or a part of the engaging portion 513 of the vessel body 510 (FIG. 7B) to a position where the receiving portion 523 of the vessel cap 520 is engaged with the engaging portion 513 of the vessel body 510 (FIG. 7C). It should be understood that the vessel body 510 may be configured to be movable along at least two axes as defined by the shaft 530 in addition to the vessel cap 520 in a similar fashion as the vessel cap 520.

In one embodiment, the shaft 530 is configured to prevent movement beyond the rotational movement and the vertical movement as described and shown in FIGS. 7A-7C. In one embodiment, the shaft 530 is configured with sufficient rigidity such that tilting or bending movement of the shaft is substantially prevented. The two axes movement of the vessel cap 520 connected to the vessel body 510 via a shaft 530 may be advantageous in some situations since it enables and assists with one hand manipulation of the vessel assembly. For example, a closed laboratory vessel assembly may be opened where an user can use one or two fingers to push the vessel cap 520 upwardly to disengage the vessel cap 520 from the vessel body 510 and then rotate the vessel cap 520 away from the vessel body 510 to expose the open end 512 of the vessel body 510 to access the interior of the vessel body 510. The vessel assembly may be closed by performing the above exemplary procedure in reverse.

It is noted that the support of the shaft 530 enables and/or at least facilitate the ease of operation of the opening/closing procedure. The shaft 530, especially configured with sufficient rigidity, serves as a guide to the user by preventing movements of the vessel cap 520 beyond the rotational and/or vertical axial movements to ensure that the vessel cap 520 is always within the reach of the user for one hand operation. For example, in contrast with the present embodiments, if a vessel cap tethered with a shaft is capable of additional axis of movement, the shaft may tilt such that the vessel cap may be out of the reach the user or may become difficult to manipulate by the user with just one hand.

Referring now to FIGS. 8A-8C, an embodiment of the laboratory vessel assembly configured as a flask assembly is shown comprising a vessel body 610, a vessel cap 620 and a shaft 630 connecting or linking the vessel body 610 and the vessel cap 620.

In one embodiment, as seen in FIGS. 8A-8C, a first portion 631 of the shaft 630 is integrally connected to the vessel body 610, the second portion 632 of the shaft 630 is received by a receiving sheath 640 that is integrally connected to the vessel cap 620. In another embodiment, the shaft may not be integrally connected with the cap or the vessel body, where the shaft is received by a first receiving sheath connected to the vessel body and a second receiving sheath connected to the vessel cap. In still yet another embodiment, the shaft may be integrally connected with both the cap and the vessel body.

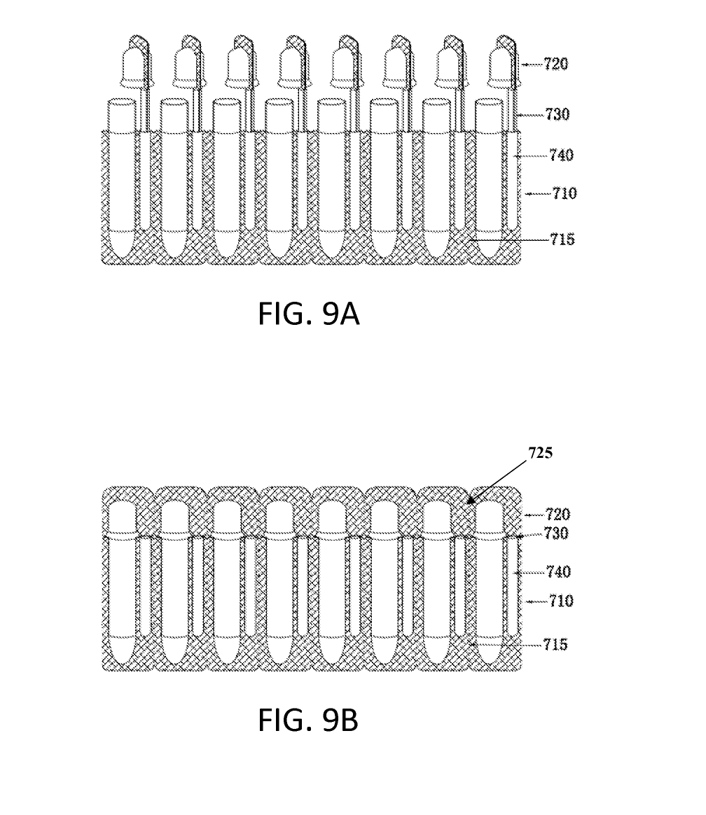

Referring now to FIGS. 9A-9B, where a laboratory vessel assembly comprising a plurality of vessel bodies, caps, and shafts are exemplarily shown. As seen in FIG. 9A, a laboratory vessel body unit comprising a vessel body 710 and a receiving sheath 740 is connected to one or more additional vessel body units that are substantially identical along a connection portion 715. In one embodiment, the connected vessel body units are configured to be parallel to one another and equally spaced apart to form an elongated vessel body strip. Additionally, a vessel cap unit comprising a vessel cap 720 and a shaft 730 is connected to one or more additional vessel cap units that are substantially identical along a connection portion 725. In one embodiment, the connected vessel body units and the vessel cap units are configured to be parallel to one another and equally spaced apart to form an elongated vessel cap unit strip.

In one embodiment, the spacing of the connected cap units are configured to correspond to the spacing of the connected body units such that the elongated vessel cap strip is configured to engage with the elongated vessel body strip to function as a strip vessel assembly. The shafts of the cap units are configured to be received by the receiving sheaths of the body units. The vessel caps of the cap units are further configured to engage with the vessel bodies of the body units. In one embodiment, the spacing of the connected vessel caps are configured to correspond to the spacing of the connected vessel bodies such that the elongated vessel cap strip is configured to engage with the elongated vessel body strip to function as a strip vessel assembly. The strip vessel assembly may be used in manual and/or automated laboratory procedures to enable multiple procedures to be carried out concurrently. For example, as seen in FIG. 9B, a plurality of the body units each comprising a vessel body 710 and a receiving sheath 740 may be connected in a strip configuration while the cap units each comprising the vessel cap 720 and the shaft 730 may be separate units thus maintaining the connected body structure while enabling individual manipulation of the vessel caps 720.

Alternatively, in one embodiment, the connected body units are capable of being separated at a tear line connection portions, such as a perforated portion, wherein one vessel body is capable of being separated from the elongated vessel body strip by tearing along the tear line connection portions. Similarly, in one embodiment, the connected cap units are capable of being separated at a tear line connection portions, such as a perforated portion, wherein one vessel cap is capable of being separated from the elongated vessel cap strip by tearing along the tear line connection portions. This embodiment may be advantageous for the storage of the laboratory assembly where the vessel bodies and the vessel caps are stored as vessel body strips and vessel cap strips, when a need for a vessel assembly arises, the user can separate one cap and on vessel from the strips. It should be noted that the configuration of the cap unit and the body unit may be altered where the body unit comprises the vessel body and the shaft and the cap unit comprise the vessel cap and the receiving sheath.

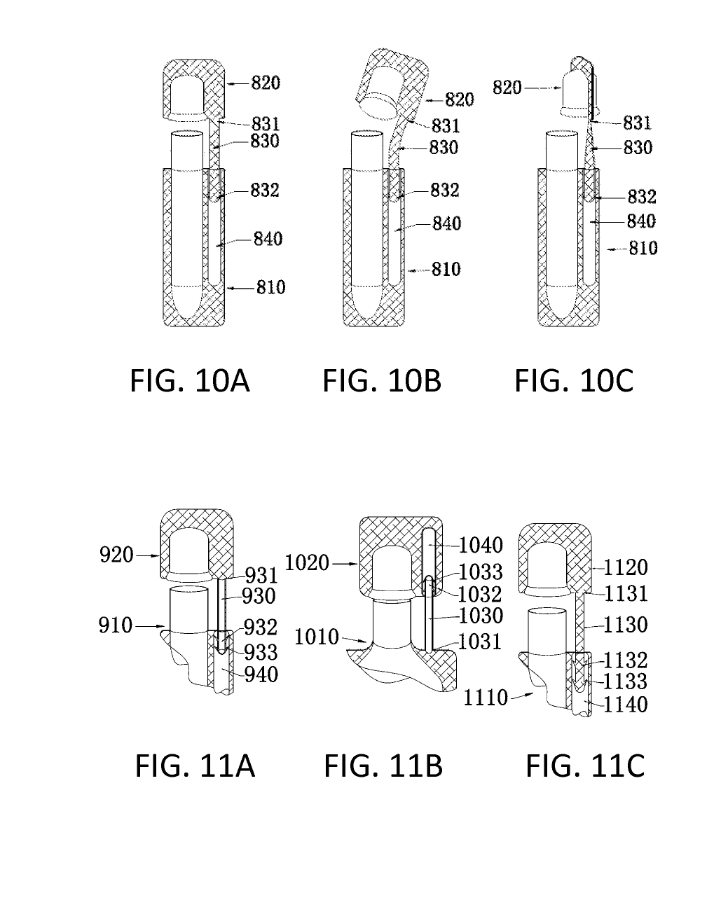

Referring now to FIGS. 10A-10C, where one embodiment of a laboratory vessel assembly with a bendable shaft is shown. The laboratory vessel assembly comprises a vessel body 810, a vessel cap 820, and a bendable shaft 830 connecting the vessel cap 820 with the vessel body 810. Furthermore, it is noted that an engaging portion of the vessel body 810 may comprise two edges disposed longitudinally on two opposite portions of an outer surface of the engaging portion. Similarly, it is noted that a receiving portion of the vessel cap 820 one or more grooves disposed on an inner surface of the receiving portion.

In one embodiment, as shown, a first portion 831 of the bendable shaft 830 is integrally connected to the vessel cap 820 and a second end 832 of the bendable shaft 830 is received by a receiving sheath 840 integrally connected to the vessel body 810. As previously discussed, in an alternative embodiment, a bendable shaft may be integrally connected with a vessel body and received by a receiving sheath integrally connected to a vessel cap. In another alternative embodiment, a bendable shaft may not be integrally connected to neither a vessel cap nor a vessel body, instead, it is received by two receiving sheaths connected to a vessel cap and a vessel body. In yet another alternative embodiment, the bendable shaft may be integrally connected to both a vessel cap and a vessel body.

In one embodiment, the bendable shaft 830 is configured to enable the vessel cap 820 to be independently capable of linear movement and rotational movement with respect to the vessel body 810. Additionally, the bendable shaft 830 is configured to enable a bending movement or side torsion movement relative to the vessel body 810 as seen in FIG. 10B. The various movements of the vessel cap 820 as supported by the bendable shaft 830 enables the vessel cap 820 and vessel body 810 to transform from closed, engaged position to an open, dis-engaged position.

In one embodiment, the bendable shaft 830 may be configured as a band that is deformable to enable the bending movement. The bendable shaft 830 configured as a band may be constructed with specific thickness or material to enable the deformability characteristics.

In one embodiment, as seen in FIG. 10C, the bendable shaft 830 comprises a first portion 831 and a second portion 832, where the first portion 831 is disposed near or connected to the vessel cap 820 and the second portion 832 is disposed near or is the portion that is received by the receiving sheath 840. In one embodiment, the first portion 831 is configured to be thinner than the second portion 832. The thinner first portion 831 facilitates or enables the bending movement of the shaft 830 near the vessel cap 820 while the thicker second portion 832 is configured to limit the bending movement of the shaft 830 near the vessel body 810, thus enables structural support of the vessel cap 820 and limits the movement of the cap 820 beyond the scope of one hand operation. In one embodiment, the bendable shaft 830 may assume a tapered configuration where the thickness of the shaft decreases from the first section 831 to the second section 832 as seen in FIG. 10C. In another embodiment, the bendable shaft is configured as a band configuration of equal thickness throughout.

Referring now to FIG. 11A, where one embodiment of a vessel assembly comprising a vessel body 910 integrally connected to a receiving sheath 940 and a vessel cap 920 integrally connected to a shaft 930 is exemplarily shown. As seen in FIG. 11A, the shaft 930 comprises a first portion 931 and a second portion 932, wherein the first portion 931 is integrally connected to the vessel cap 920 and the second portion 932 is configured to be received by the receiving sheath 940. The shaft 930 further comprises one or more locking elements 933 disposed at or near the second portion 932 of the shaft 930 that is to be received by the sheath 940.

Referring now to FIG. 11B, where one embodiment of a vessel assembly comprising a vessel body 1010 integrally connected to a shaft 1030 and a vessel cap 1020 integrally connected to a receiving sheath 1040 is exemplarily shown. As seen in FIG. 11B, the shaft 1030 comprises a first portion 1031 and a second portion 1032, wherein the first portion 1031 is integrally connected to the vessel cap 1020 and the second portion 1032 is configured to be received by the receiving sheath 1040. The shaft 1030 further comprises one or more locking elements 1033 disposed at or near the second portion 1032 of the shaft 1030 that is to be received by the sheath 1040.

Referring now to FIG. 11C, where one embodiment of a vessel assembly comprising a vessel body 1110 connected to a receiving sheath 1140 and a vessel cap 1120 connected to a bendable shaft 1130 is exemplarily shown. As seen in FIG. 11C, the bendable shaft 1130 comprises a first portion 1131 and a second portion 1132, wherein the first portion 1131 is integrally connected to the vessel cap 1120 and the second portion 1132 is configured to be received by the receiving sheath 1140. The shaft 1130 further comprises one or more locking elements 1133 disposed at or near the second portion 1132 of the shaft 1130 that is to be received by the sheath 1140.

In one embodiment, the locking elements 933, 1033, or 1133 as seen in FIGS. 11A-11C comprises one or more converse spines configured to secure the shaft once the shaft is inserted into the receiving sheath, whereby the orientation of the spines enables one directional movement of the shaft in to the sheath while preventing or hinder the opposing directional movement of the shaft away from the sheath.

Alternatively or additionally, in one embodiment, the receiving sheath may comprise one or more locking elements, instead of, or in addition to the locking elements as disposed on the shaft. For example, the locking element configured as one or more converse spines configured to secure the shaft once the shaft is inserted into the receiving sheath as described above may be disposed within the sheath.

It is contemplated that various embodiments as described above may be configured in various combinations thereof. For example, it should be understood that the various embodiments of the laboratory vessel assembly comprising a shaft may be additionally configured with edges disposed on the vessel body and/or grooves disposed on the vessel cap as previously described such that an embodiment of the laboratory vessel assembly is afforded the advantages of aeration of an interior of the vessel body as provided by the aeration gaps created by the interaction of the grooves and/or edges in addition to the ease of manipulation provided by the vessel body-shaft-vessel cap configuration.

It is further contemplated that various embodiments of the laboratory vessel assembly comprising a vessel body, a vessel cap, a shaft, and a receiving sheath may be constructed by fusing two parts along a fusion line. In one embodiment, two base materials such as two plastic sheets are fused together along a fusion line to form the vessel body, the vessel cap, the shaft, and/or the receiving sheath by applying one or more methods of manufacturing described in greater detail below.

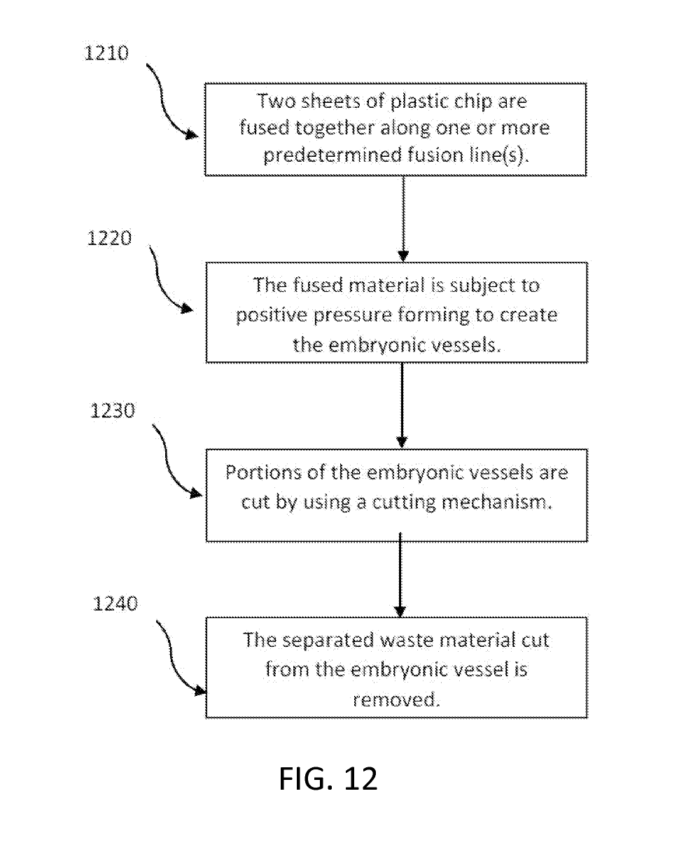

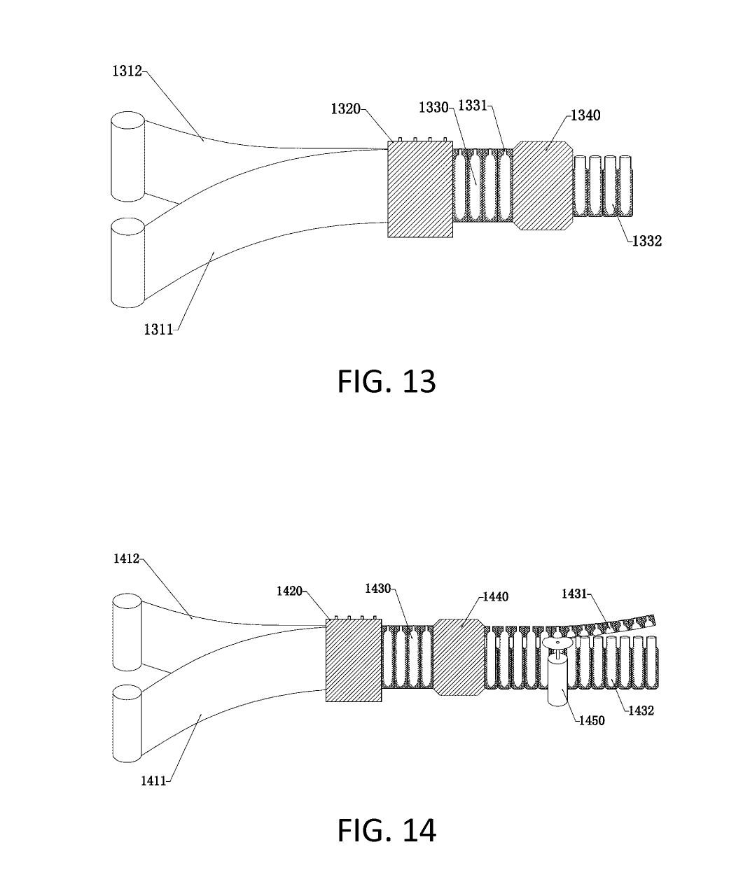

The present disclosure also provides for methods of manufacturing a laboratory vessel assembly. FIG. 12 illustrates a flow diagram showing one exemplary method of manufacturing components of a laboratory vessel assembly using plastic chip positive pressure forming (or blow molding). Various steps as shown in FIG. 12 are further illustrated in FIG. 13.

At step 1210, two sheets of base material, such as two overlapping plastic chips or sheets 1311 and 1312 are heated and fused together along one or more predetermined fusion lines by a mechanism 1320 capable of thermo-fusion or compression fusion. In one embodiment, the sheets may be pre-cut to specific dimensions or pre-treated prior to the fusion process. In one embodiment, the base material may be configured as, but not limited to PVC, PE, PP, PVDC, PVC/PE, PS/PE and PET/PE chips, and any other copolymer plastic chips or sheets.

At step 1220, the fused sheets is subject to positive pressure forming (blow molding) via one or more openings formed by the fused sheets to achieve a desired embryonic space and/or shape. For example, a pressurized gas may be injected into a space of the fused sheets via the openings to create an embryonic vessel assembly. In one embodiment, the heat fusion step and the positive pressure forming step are completed simultaneously.

The product of the heat fusion and the positive pressure forming is an embryonic vessel 1330. The embryonic vessel 1330 contains aspects of the final laboratory vessel component, however, it must be further processed to achieve the final and usable configuration.

At step 1230, one or more portions of the embryonic vessel 1330 are cut by using a cutting mechanism 1340 along one or more pre-determined cutting lines. The cutting mechanism 1340 may be configured to be capable of punch cutting, die-cutting, mini-blade cutting, laser cutting or other cutting techniques known in the art. At step 1240, the separated waste material 1331 cut from the embryonic vessel 1330 is removed and the remaining portion 1332 of the embryonic vessel 1330 now assumes substantially the configuration of the final vessel component such as a vessel body or a vessel cap.

Additionally or alternatively, as seen in FIG. 14, in one embodiment, the embryonic vessels may be subject to a multi-cutting processing. A plurality of embryonic vessels 1430 is produced by fusing two sheets of base material, such as two plastic sheets 1411 and 1412 along one or more predetermined fusion lines by a mechanism 1420 capable of thermo-fusion or compression fusion and positive pressure forming as described above.

The embryonic vessels 1430 are then subject to a first cutting processing, exemplarily shown as punch cutting by a first cutting mechanism 1440 such as a punch cutter. As seen in FIG. 14, in one embodiment, the first cutting processing removes portions of materials between the sides of the embryonic vessels 1430 along a first set of one or more cutting lines thereby creating engaging portions and two edges along the fusion lines of an outer surface of the embryonic vessels 1430. Thereafter, the embryonic vessels 1430 are subject to a second cutting processing to create openings, where the second cutting mechanism 1450 is exemplarily shown as a blade cutter. The second cutting processing separates portions from the top or bottom of the embryonic vessels 1430 along a second set of one or more cutting lines, where the waste material 1431 separated from the embryonic vessels 1430 by the second cutting processing is removed to produce vessel components 1432 the now assume substantially the final configuration.

The multi-step cutting methods as described and shown may be advantageous by allowing a diversified cutting methods be employed to best process the specific cutting need. For example, punch cutting may be effective for removing waste materials between the embryonic vessels and blade cutting may be effective for removing waste materials on top or bottom of the embryonic vessels. It is contemplated that more than two cutting steps may be used and various cutting techniques and mechanisms may be used.

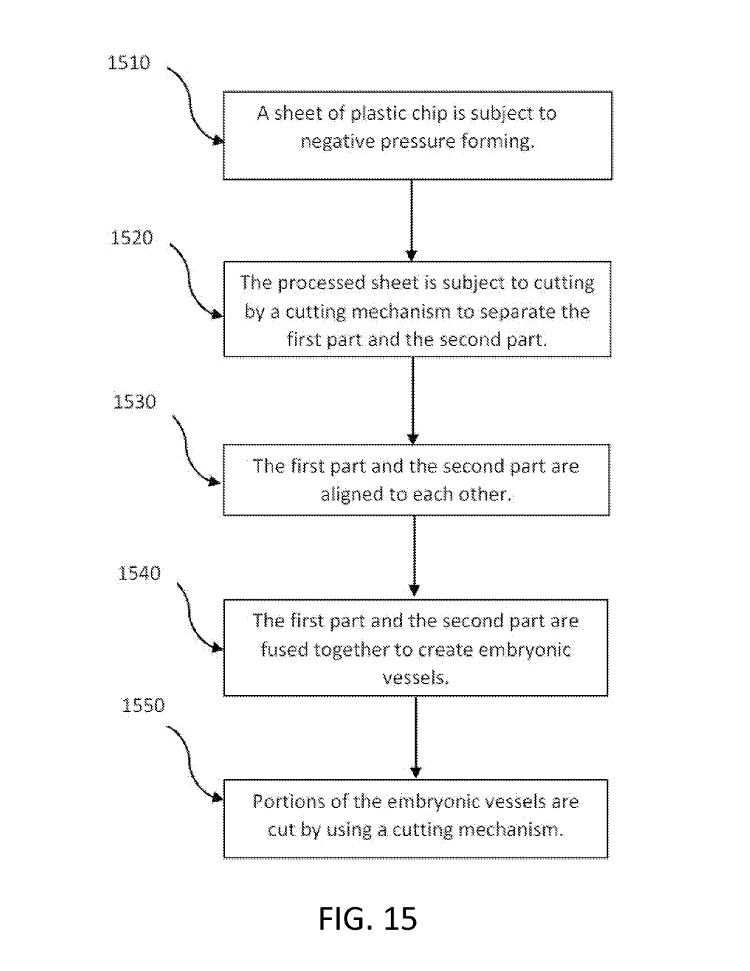

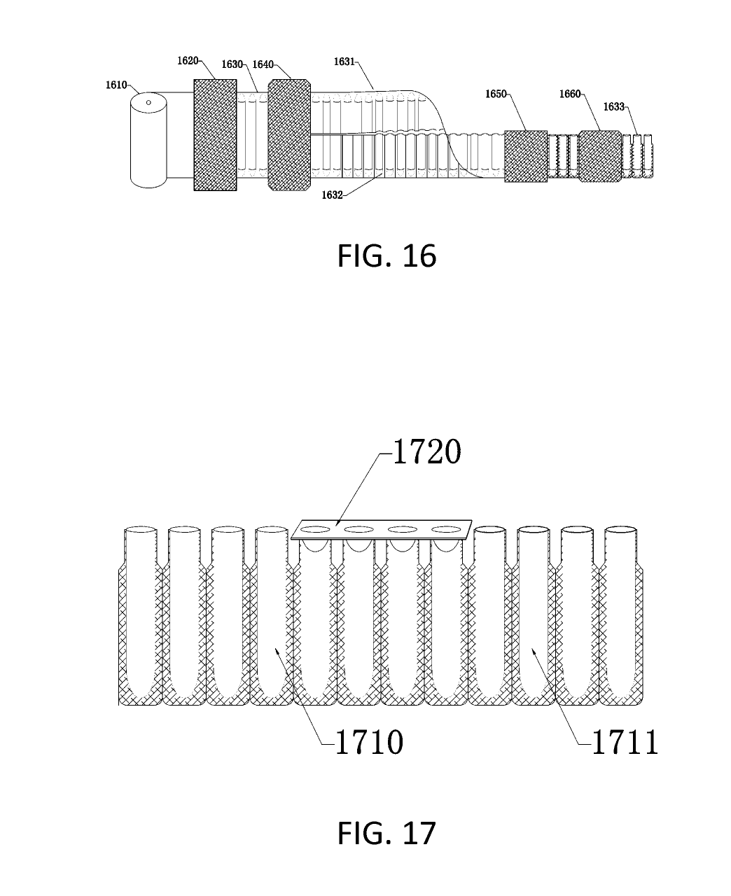

FIG. 15 illustrates a flow diagram showing one exemplary method of manufacturing components of a laboratory vessel assembly using negative pressure forming (vacuum molding). Various steps as shown in FIG. 15 are further illustrated in FIG. 16.

At step 1510, a base sheet 1610 such as a plastic sheet or chip is subject to negative pressure forming (vacuum molding) by a mechanism 1620. For example, the mechanism 1620 may be a vacuum mold, where vacuum may be applied to the sheet 1610 to form a processed sheet 1630 that comprises a first part 1631 and second part 1632, where the first part 1631 and the second part 1632 reflects various structural elements of the embryonic vessels. In one embodiment, the first part 1631 and the second part 1632 are mirror images of each other. As seen in FIG. 16, the first part 1631 and the second part 1632 are connected along a connection line. At step 1520, the processed sheet 1630 is subject to cutting by a cutting mechanism 1640 to separate the first part 1631 and the second part 1632 along the connection line. At step 1530, the now separated first part 1631 and the second part 1632 as shown exemplarily as the front part and the back part of a plurality of tube assemblies are aligned to each other. At step 1540, the aligned first part 1631 and the second part 1632 are fused together by a sealing mechanism 1650 such as thermo-sealer or an ultrasonic plastic welding sealer to form embryonic vessels. The embryonic vessels contain aspects of the final laboratory vessel component, however, it must be further processed to achieve the final and usable configuration. At step 1550, waste materials are removed be a second cutting mechanism 1660 along one or more cutting lines to produce the final vessel components 1633.

The vessel components produced by the positive pressure forming or the negative pressure forming may be further processed. In one embodiment, as seen in FIG. 17, vessel components 1710 are subject to heat treatment by a heat block 1720 to melt any excess materials that may be result of the cutting process to enhance the opening strength of the openings in the final product 1711. It is further noted that the heat block treatment affects the vessel components 1710 by smoothing the openings.

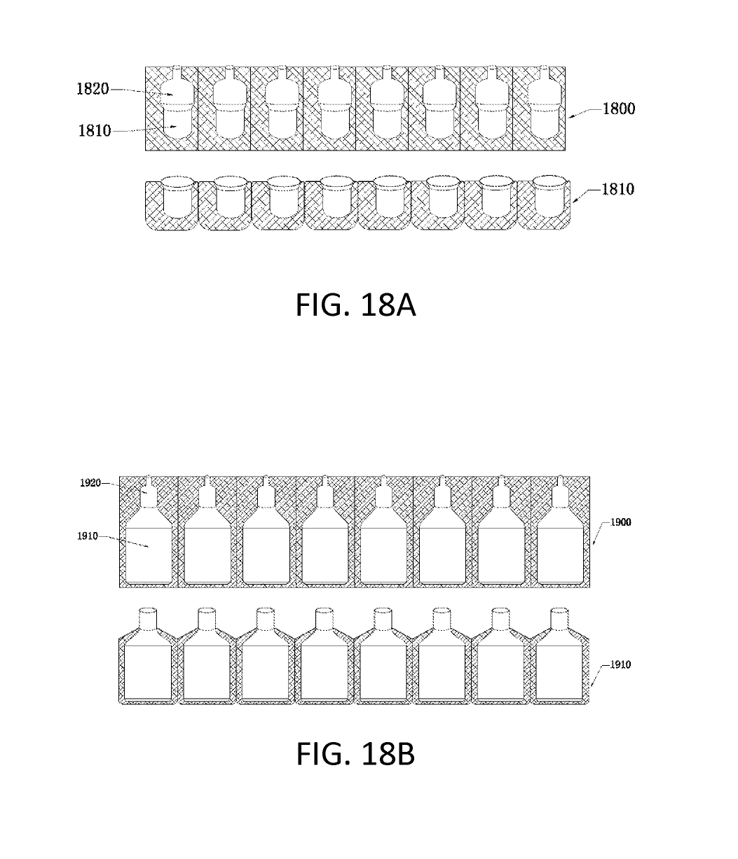

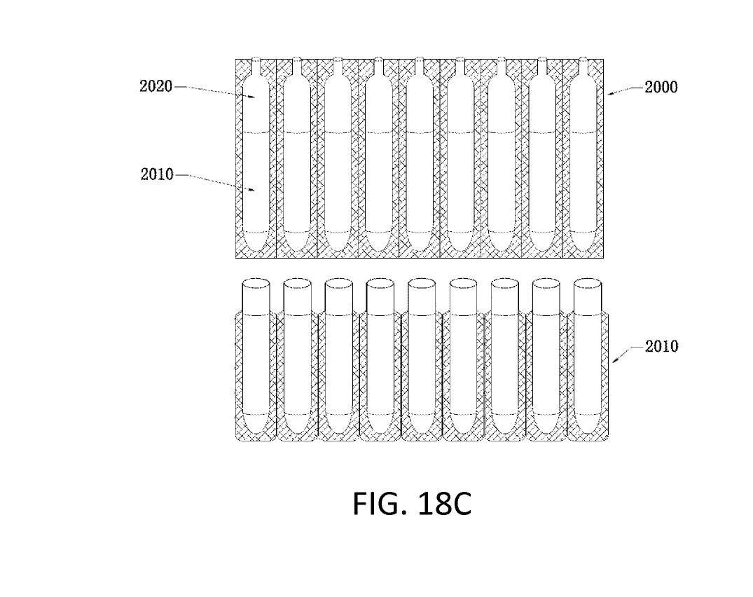

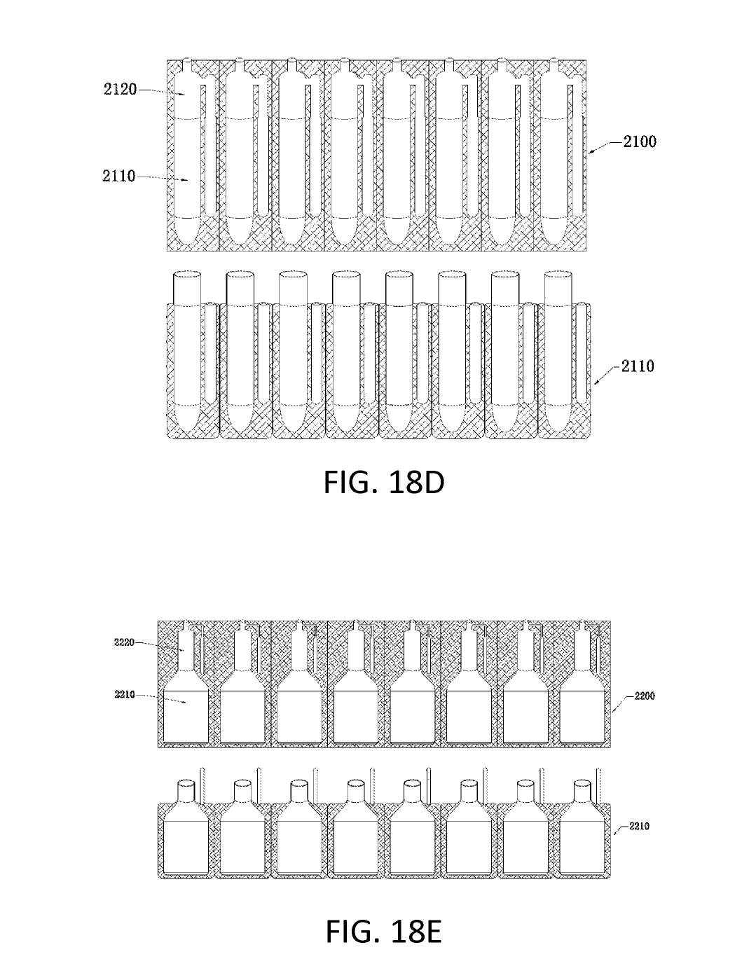

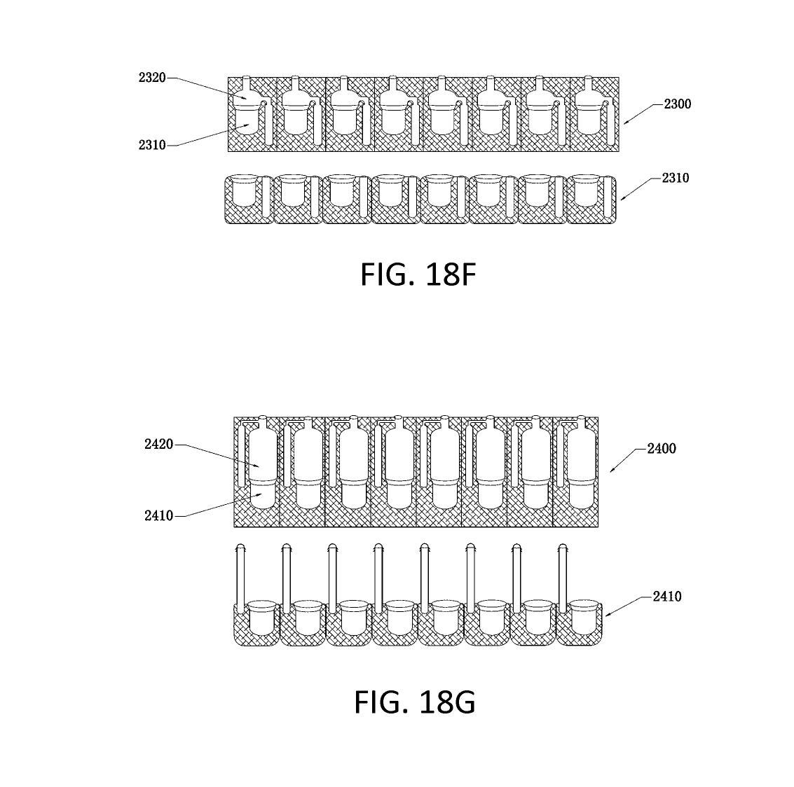

Referring now to FIGS. 18A-18G, where various embodiments of the embryonic vessel and the resulting vessel component as previously described are shown. Although various embodiments shown are described in terms of positive pressure forming methodology, it should be understood that embodiments as shown may also be produced by negative methodology as well as any alternative and/or optional techniques such as multi-step cutting and heat treatment to strengthen the openings.

As seen in FIG. 18A, a plurality of embryonic vessel caps 1800 as produced by the fusion step (step 1210) and the pressure forming step (step 1220) as previously described is shown. The plurality of embryonic vessel caps 1800 is subjected to the cutting step (step 1230), where the undesired portions 1820 are separated from the final vessel caps 1810.

As seen in FIG. 18B, a plurality of flask shaped embryonic vessel bodies 1900 as produced by the fusion step (step 1210) and the pressure forming step (step 1220) as previously described is shown. The plurality of flask shaped embryonic vessel bodies 1900 is subjected to the cutting step (step 1230), where the undesired portions 1920 are separated from the final vessel bodies 1910.

As seen in FIG. 18C, a plurality of tube shaped embryonic vessel bodies 2000 as produced by the fusion step (step 1210) and the pressure forming step (step 1220) as previously described is shown. The plurality of tube shaped embryonic vessel bodies 2000 is subjected to the cutting step (step 1230), where the undesired portions 2020 is separated from the final vessel bodies 2010.

As seen in FIG. 18D, a plurality of tube shaped embryonic vessel bodies 2100 with receiving sheaths configured to receive shafts as produced by the fusion step (step 1210) and the pressure forming step (step 1220) as previously described is shown. Furthermore, it is noted that in addition to shaping the vessel space, the receiving sheaths are also produced by the fusion and pressure forming steps. The plurality of tube shaped vessel bodies with receiving sheaths 2100 is subjected to the cutting step (step 1230), where the undesired portions 2120 are separated from the final vessel bodies 2110.

As seen in FIG. 18E, a plurality of flask shaped embryonic vessel bodies connected to a plurality of shafts 2200 as produced by the fusion step (step 1210) and the pressure forming step (step 1220) as previously described is shown. Furthermore, in one embodiment, it is noted that in addition to shaping the vessel body space, the shafts are also produced by the fusion and pressure forming steps. The plurality of flask shaped embryonic vessel bodies with shafts 2200 is subjected to the cutting step (step 1230). Specifically, the undesired portions 2220 including the portion around the embryonic shafts are separated from the final vessel bodies 2210.

As seen in FIG. 18F, a plurality of embryonic caps connected to a plurality of receiving sheaths 2300 as produced by the fusion step (step 1210) and the pressure forming step (step 1220) as previously described is shown. Furthermore, in one embodiment, it is noted that in addition to shaping the cap space, the receiving sheaths are also produced by the fusion and pressure forming steps. The plurality of embryonic caps with receiving sheaths 2300 is subjected to the cutting step (step 1230), where the undesired portions 2320 are separated from the final vessel caps 2310.

As seen in FIG. 18G, a plurality of embryonic vessel caps connected to a plurality of shafts 2400 as produced by the fusion step (step 1210) and the pressure forming step (step 1220) as previously described is shown. Furthermore, in one embodiment, it is noted that in addition to shaping the vessel cap space, the shafts are also produced by the fusion and pressure forming steps. The plurality of embryonic vessel caps connected to the plurality of shafts 2400 is subjected to the cutting step (step 1230), specifically, the undesired portions 2420 including the portions around the embryonic shafts are separated from the final vessel caps 2410.

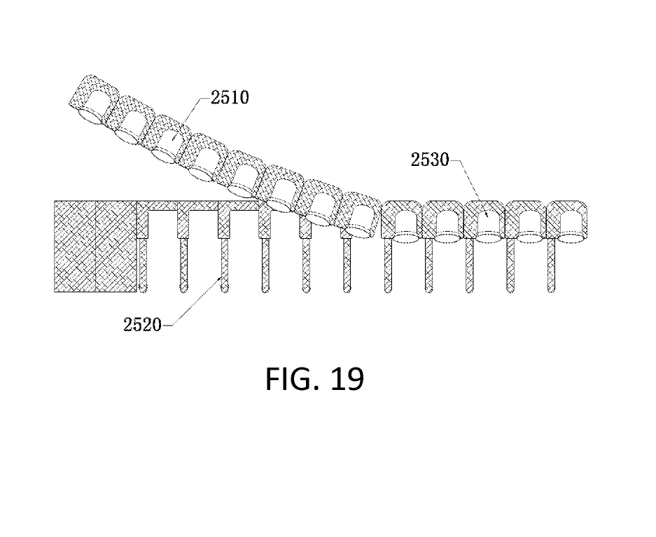

Referring now to FIG. 19, an embodiment of producing a plurality of vessel caps where each cap is connected to a shaft is shown. In one embodiment, a plurality of vessel caps 2510 and a plurality of shafts 2520 are produced separately. In one embodiment, the plurality of vessel caps 2510 and a plurality of shafts 2520 may be produced using the procedures as described above. The plurality of vessel caps 2510 and a plurality of shafts 2520 are configured to be correspondingly spaced such that alignment of the shafts and the vessel caps may be achieved. Once the plurality of vessel caps 2510 and a plurality of shafts 2520 are aligned, the vessel caps 2510 and the shafts 2520 are fused together by thermo-fusion or compression fusion to produce a plurality of caps with connecting shafts 2530. It is noted that the shafts exemplarily shown may be the rigid configurations as described above and shown in FIGS. 7A-7C or the bendable configurations as described above and shown in FIGS. 10A-10C.

Additional or alternative embodiments of methods of manufacturing a laboratory vessel assembly are now described. Although as exemplarily shown FIG. 13 an FIG. 14, two sheets of a base material are fused together along a first set of predetermined fusion lines, in one embodiment, a third and/or a fourth sheets may be aligned and fused to the first and/or second sheets contemporaneously or sequentially at a second set of fusion lines to reinforce one or more sections of the resulting vessel components. For example, the third and the fourth sheets may be used to reinforce the openings of the vessel bodies. Additionally, it is contemplated that third and the fourth sheets may be used to reinforce the openings of the vessel caps, the shafts, the receiving sheaths, or the like. The embryonic vessels reinforced with the third and/or the fourth sheets are then subject to cutting by a cutting mechanism as previously described to produce reinforced vessel components.

The third and the fourth sheets may be pre-configured to dimensions that is smaller than the first and the second sheets. The pre-configured dimensions of the third and the fourth sheets and placement of the third and fourth limit the reinforcement to a particular portions of the vessel components, such as the vessel body openings. During the fusion step the third and the fourth sheets may be aligned to the particular portions of the vessel components, such as the vessel body openings, to achieve reinforcement to the vessel body openings.

Although as described, the third and the fourth sheets may be used to reinforce the vessel components, it is contemplated that any number of sheets may be used. For example, a single sheet may be used to reinforce the vessel components, alternatively, three or more sheets may be used to reinforce various portions of the vessel components. It is further contemplated that the sheets may be selected from a plurality of materials where, in one embodiment, the composition of the first and the second sheets may be different from the composition of the third and the fourth sheets.

Additionally, as described, the third and a fourth sheets may be aligned and fused to the first and second sheets contemporaneously with the fusion of the first and the second sheets, alternatively, it is contemplated that the third and the fourth sheets and may be fused to the first and the second sheets after the fusion of the first and the second sheets by the fusion mechanism. In another embodiment, the third sheet may be fused to the first sheet and the fourth sheet may be fused to the second prior to the fusion of the first and the second sheets.

Furthermore, it is contemplated that a single sheet may be used to produce the laboratory vessel component using positive pressure forming. In one embodiment, a single sheet of a base material is folded to produce two overlapping sheets. Thereafter, the first and the second overlapping sheets are aligned and fused together along predetermined fusion lines by a mechanism capable of thermo-fusion or compression fusion. The resulting embryonic vessels are cut by a cutting mechanism as described above. The folding manufacturing method may be advantageous to produce vessel bodies configured as flat bottom flasks since the folding procedure produces a folded portion that is not subject to the fusion steps and thus may be configured as the flat bottom of the vessel body.

It is contemplated that various additional or optional steps of manufacturing methods may be utilized in addition to the methods described above. For example, fusiform or spindle indentation methods may be used to produce the ridges on the vessel caps or the threads on the vessel body and/or the vessel cap.

It is noted that manufacturing methods described above may be applied to produce various embodiments of laboratory vessel assembly including, but not limited to various embodiments described herein such as vessel body configurations comprising edges, vessel cap configurations comprising grooves, vessel body configurations connected to a shaft or a receiving sheath, vessel cap configurations connected a shaft or a receiving sheath, or any combinations thereof.

It is noted that the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A laboratory vessel assembly, comprising:
a vessel body comprises a first part and a second part fused together along one or more fusion lines of the vessel body, wherein the vessel body comprises a closed end, an open end, an engaging portion disposed inbetween, and two edges disposed longitudinally on two opposite portions of an outer surface of the engaging portion of the vessel body along the fusion lines of the vessel body;
a vessel cap comprises a first part and a second part fused together along one or more fusion lines of the vessel cap, wherein the vessel cap comprises a closed end, an open end, a receiving portion disposed inbetween, and one or more grooves disposed on an inner surface of the receiving portion along the fusion lines of the vessel cap;
wherein the receiving portion of the vessel cap is configured to engage with the engaging portion of the vessel body to create one or more aeration gaps between the vessel body and the vessel cap along the grooves of the vessel cap and/or the edges of the vessel body.

2. The laboratory vessel assembly of claim 1, wherein a diameter of the open end of the vessel cap is configured to be greater than a diameter of the receiving portion of the vessel cap such that the vessel cap assumes a bell bottom shape.

3. The laboratory vessel assembly of claim 1, wherein the vessel body is connected to one or more vessel bodies by one or more tear line connection portions at the fusion lines of the vessel body to form a plurality of connected vessel bodies and wherein the connected vessel bodies are configured to be parallel to one another and equally spaced apart to form an elongated vessel body strip.

4. The laboratory vessel assembly of claim 3, wherein the connected vessel bodies is capable of being separated at the tear line connection portions such that one vessel body is capable of being separated from the elongated vessel body strip.

5. The laboratory vessel assembly of claim 1, wherein the vessel cap is connected to one or more vessel caps by a tear line connection portion at the fusion lines of the vessel cap to form a plurality of connected vessel caps, and wherein the connected vessel caps are configured to be parallel to one another and equally spaced apart to form an elongated vessel cap strip.

6. The laboratory vessel assembly of claim 5, wherein the plurality of connected vessel caps is capable of being separated at the tear line connection portions such that one vessel cap is capable of being separated from the elongated vessel cap strip.

7. The laboratory vessel assembly of claim 1, wherein the vessel cap comprises ridges on the inner surface of the vessel cap formed by fusiform or spindle indentations of the receiving portion of vessel cap.

8. A laboratory vessel assembly, comprising:
a vessel body comprises a closed end, an open end, an engaging portion disposed inbetween, and two edges disposed longitudinally on two opposite portions of an outer surface of the engaging portion;
a vessel cap comprises a closed end, an open end, a receiving portion disposed inbetween, and one or more grooves disposed on an inner surface of the receiving portion;
a shaft linking the vessel body and the vessel cap;
wherein the vessel cap is configured to be movable along at least two axes such that the vessel cap is capable of linear movement along the first axis which is defined from the closed end of the vessel body toward the open end of the vessel body and rotational movement along the second axis which is perpendicular or parallel to the first axis and wherein the vessel cap is capable of transforming from a position where the receiving portion of the vessel cap is engaged with the engaging portion of the vessel body to a position where the receiving portion of the cap is disengaged with the engaging portion of the vessel body.

9. The laboratory vessel assembly of claim 8, wherein the vessel cap or the vessel body is connected to a receiving sheath configured to receive the shaft.

10. The vessel assembly of claim 9, wherein the shaft comprises a locking element, wherein the locking element comprises one or more converse spines configured to secure the shaft once the shaft is inserted into the receiving sheath.

11. The laboratory vessel assembly of claim 9, wherein the receiving sheath comprises a narrowed opening configured to permit the shaft being forced into the sheath and configured to prevent the shaft from being pulled out from the sheath.

12. The laboratory vessel assembly of claim 8, wherein the shaft is configured to be bendable and wherein the cap is capable of forward and backward bending movement relative to the vessel body.

13. The laboratory vessel assembly of claim 8, wherein a diameter of the open end and the receiving portion of the vessel cap is greater than a diameter of the open end and the engaging portion of the vessel body.

14. The laboratory vessel assembly of claim 8, wherein the vessel cap comprises ridges on the outer surface of the vessel cap formed by fusiform or spindle indentations of the receiving portion of vessel cap.

15. A method of manufacturing a laboratory vessel body by positive pressure forming, comprising the steps of:
a) heating two overlapping sheets of plastic chip to fuse the sheets along one or more predetermined fusion lines in a mold;
b) injecting gas to a space between the fused sheets to create an embryonic vessel assembly;
c) cutting the embryonic vessel assembly along a first set of one or more cutting lines to produce one or more openings for the vessel body; and
d) cutting the embryonic vessel assembly along a second set of one or more cutting lines to produce two edges disposed on an outer surface of the vessel body.

16. The method of claim 15, wherein the opening of vessel body is further subject to thermo-processing to smooth the opening and to enhance the strength of the opening.

17. The method of claim 15, wherein the cutting steps comprise applying punch cutting, spin disc blade cutting, or laser cutting or a combination thereof.

18. The method of claim 15, wherein the vessel body is produced to be integrally connected with a shaft.

19. The method of claim 15, wherein the vessel body is produced to be integrally connected with a receiving sheath.

20. The method of claim 15, wherein the two overlapping sheets are produced by folding a single plastic sheet.
